(19) United States
(12) Patent Application Publication
(10) Pub. No.: US 2017/0226827 A9
(43) Pub. Date: Aug. 10, 2017

(54) METHODS OF TREATING A SUBTERRANEAN FORMATION WITH SHRINKABLE FIBERS

(71) Applicant: SCHLUMBERGER TECHNOLOGY CORPORATION, Sugar Land, TX (US)

(72) Inventors: Diankui Fu, Kuala Lumpar (MY); Sergey Semenov, Kurgan (RU); Alexey Alekseev, Novosibirsk (RU)

(21) Appl. No.: 14/517,473

(22) Filed: Oct. 17, 2014

(30) Foreign Application Priority Data
Oct. 17, 2013 (RU) PCT/RU2013/000919

(51) Int. Cl. E21B 43/02; E21B 43/26; C09K 8/592; E21B 43/24

(52) U.S. Cl. CPC E21B 43/02; E21B 43/24; E21B 43/26; C09K 8/592; C09K 2208/08

(57) ABSTRACT

Methods of treating a subterranean formation are disclosed that include introducing a treatment fluid including thermally shrinkable fibers and a particulate material into a subterranean formation via a wellbore, adjusting at least one parameter of the treatment fluid to trigger the association of the thermally shrinkable fibers, and forming a porous pack including a network of shrunken fibers by applying heat sufficient to raise the temperature of the thermally shrinkable fibers to a temperature at or above a shrinking initiation temperature of the thermally shrinkable fibers.

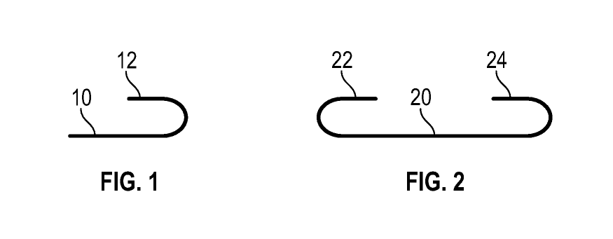

### CROSS-REFERENCE TO RELATED APPLICATION

This application claims priority to PCT Patent Application No. PCT/RU2013/000919 (entitled “Methods of Treating a Subterranean Formation With Shrinkable Fibers”—SLB Docket No. IS13.3567-WO-PCT), filed Oct. 17, 2013. The content of this application is incorporated by reference herein in its entirety.

### BACKGROUND

Hydrocarbons (oil, natural gas, etc.) may be obtained from a subterranean geologic formation (a “reservoir”) by drilling a well that penetrates the hydrocarbon-bearing formation. Well treatment methods often are used to increase hydrocarbon production by using a treatment fluid to interact with a subterranean formation in a manner that ultimately increases oil or gas flow from the formation to the wellbore for removal to the surface.

In the treatment of subterranean formations, one may place particulate materials as a filter medium in the near wellbore region, or sometimes in fractures extending outward from the wellbore. In fracturing operations, proppant is carried into fractures created when hydraulic pressure is applied to these subterranean rock formations in amounts such that fractures are developed in the formation. Proppant suspended in a viscosified fracturing fluid is then carried out and away from the wellbore within the fractures (as the fractures are created) and extended with continued pumping. Ideally, upon release of pumping pressure, the proppant materials remain in the fractures, holding the separated rock faces in an open position forming a channel for flow of formation fluids back to the wellbore.

However, one potential concern for some fracturing jobs is proppant flowback. Proppant flowback is the transport of proppant back into the wellbore with the production of formation fluids following fracturing. This undesirable result causes several undesirable problems: (1) undue wear on production equipment, (2) the undertaking of a separation procedure to remove solids from the produced fluids and (3) a decrease in the efficiency of the fracturing operation because the proppant does not remain within the fracture and may decrease the size of the created flow channel.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter. Furthermore, the concepts described below are not necessarily limited to oilfield and/or oilfield service applications and may be employed in any suitable industry, such as, for example, the construction industry (insulation, concrete mixers, etc.), fabric manufacturing and plastic manufacturing.

In some embodiments, the present disclosure describes a method for treating a subterranean formation including introducing a treatment fluid including thermally shrinkable fibers and a particulate material into a subterranean formation via a wellbore, and then adjusting a parameter of the treatment fluid to trigger a mechanical association of the thermally shrinkable fibers. After triggering the mechanical association of the thermally shrinkable fibers, a porous pack is formed that includes a network of shrunken fibers by applying heat sufficient to raise the temperature of the thermally shrinkable fibers to a temperature at or above a shrinking initiation temperature of the fibers.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation—specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, (1) even if numerous specific data points within the range are explicitly identified, (2) even if reference is made to a few specific data points within the range, or (3) even when no data points within the range are explicitly identified, it is to be understood (i) that the inventors appreciate and understand that any conceivable data point within the range is to be considered to have been specified, and (ii) that the inventors possessed knowledge of the entire range, each conceivable sub-range within the range, and each conceivable point within the range. Furthermore, the subject matter of this application illustratively disclosed herein suitably may be practiced in the absence of any element(s) that are not specifically disclosed herein.

Fibers may be used for various purposes in oilfield treatment operations. The methods of the present disclosure use thermally shrinkable fibers as a component in a treatment fluid. The methods of the present disclosure may be used to prevent and/or inhibit the flow of one or more particles, such as proppant, natural formation particulates and fines, back through the wellbore (such as during the production of formation fluids (hydrocarbons or oil) in a fracturing operation), for example, by strengthening and stabilizing the porous pack (such as a proppant pack) formed downhole.

As used herein, the term “treatment fluid,” refers to any pumpable and/or flowable fluid used in a subterranean operation in conjunction with a desired function and/or for a desired purpose. Such treatment fluids may be modified to contain thermally shrinkable fibers and/or the shrunken fibers generated therefrom (and optionally thermally non-shrinkable fibers). In some embodiments, the pumpable and/or flowable treatment fluid may have any suitable viscosity, such as a viscosity of from about 1 cP to about 10,000 cP (such as from about 10 cP to about 1000 cP, or from about 10 cP to about 100 cP) at the treating temperature, which may range from a surface temperature to a bottom-hole static (reservoir) temperature, such as from about 0° C. to about 150° C., or from about 10° C. to about 120° C., or from about 25° C. to about 100° C., and a shear rate (for the definition of shear rate reference is made to, for example, Introduction to Rheology, Barnes, H.; Hutton, J. F; Walters, K. Elsevier, 1989, the disclosure of which is herein incorporated by reference in its entirety) in a range of from about 1 s⁻¹ to about 100,000 s⁻¹, such as a shear rate in a range of from about 100 s⁻¹ to about 10,000 s⁻¹, or a shear rate in a range of from about 500 s⁻¹ to about 5,000 s⁻¹ as measured by common methods, such as those described in textbooks on rheology, including, for example, Rheology: Principles, Measurements and Applications, Macosko, C. W., VCH Publishers, Inc. 1994, the disclosure of which is herein incorporated by reference in its entirety.

The term “treatment,” or “treating,” does not imply any particular action by the fluid. For example, a treatment fluid placed or introduced into a subterranean formation subsequent to a leading-edge fluid may be a hydraulic fracturing fluid, an acidizing fluid (acid fracturing, acid diverting fluid), a stimulation fluid, a sand control fluid, a completion fluid, a wellbore consolidation fluid, a remediation treatment fluid, a cementing fluid, a driller fluid, a frac-packing fluid, or gravel packing fluid. In the methods of the present disclosure, any one of the above fluids may be modified to include one or more thermally shrinkable fibers and/or the shrunken fibers generated therefrom (and optionally thermally non-shrinkable fibers). The treatment fluids comprising a composition including thermally shrinkable fibers and/or the shrunken fibers generated therefrom (and optionally thermally non-shrinkable fibers), may be used in full-scale operations, pills, slugs, or any combination thereof. As used herein, a “pill” or “slug” is a type of relatively small volume of specially prepared treatment fluid placed or circulated in the wellbore.

As used herein, the term “treating temperature,” refers to the temperature of the treatment fluid that is observed while the treatment fluid is performing its desired function and/or desired purpose, such as fracturing a subterranean formation.

The term “fracturing” refers to the process and methods of breaking down a geological formation and creating a fracture, such as the rock formation around a wellbore, by pumping a treatment fluid at very high pressures (pressure above the determined closure pressure of the formation), in order to increase production rates from or injection rates into a hydrocarbon reservoir. The fracturing methods of the present disclosure may include a composition containing thermally shrinkable fibers and/or the shrunken fibers generated therefrom (and optionally thermally non-shrinkable fibers) in one or more of the treatment fluids, but otherwise use conventional techniques known in the art.

The treatment fluids of the present disclosure (and porous packs comprising shrunken fibers generated during the methods of the present disclosure) may be introduced during methods that may be applied at any time in the life cycle of a reservoir, field or oilfield. For example, the methods and treatment fluids of the present disclosure may be employed in any desired downhole application (such as, for example, stimulation) at any time in the life cycle of a reservoir, field or oilfield.

In embodiments, the treatment fluids of the present disclosure, which comprise a thermally shrinkable fiber that may be thermally triggered (such as by a thermal triggering event) to transform to a shrunken fiber, may be formed at the surface and placed or introduced into a wellbore; or the components of the treatment fluids may be separately placed or introduced into a wellbore in any order and mixed downhole.

As used herein, the term thermal “triggering event” refers to any action that increases the temperature of the thermally shrinkable fiber in an amount sufficient to initiate the shrinking of the thermally shrinkable fiber in a manner effective to generate a shrunken fiber. For example, the terms thermal “trigger”, thermal “triggering” and thermally “triggered,” as used herein, may include exposing the thermally shrinkable fiber to a thermal means, such as electromagnetic radiation, a high temperature treatment fluid and/or one or more temperatures within the subterranean formation temperature, such as bottom hole static temperature, to initiate, induce or cause the thermally shrinkable fiber to transform into a shrunken fiber. In some embodiments, the thermal triggering event may be brought about by exposure to electromagnetic radiation, such as microwaves, infrared waves and/or other radiation types, effective to raise the temperature of the thermally shrinkable fiber such that it will transform into a shrunken fiber.

A “wellbore” may be any type of well, including, a producing well, a non-producing well, an injection well, a fluid disposal well, an experimental well, an exploratory deep well, and the like. Wellbores may be vertical, horizontal, deviated some angle between vertical and horizontal, and combinations thereof, for example a vertical well with a non-vertical component.

The term “field” includes land-based (surface and sub-surface) and sub-seabed applications. The term “oilfield,” as used herein, includes hydrocarbon oil and gas reservoirs, and formations or portions of formations where hydrocarbon oil and gas are expected but may additionally contain other materials such as water, brine, or some other composition.

The methods of the present disclosure that comprise fracturing a subterranean formation, may include a composition containing a thermally shrinkable fiber that may be thermally triggered to form a shrunken fiber (upon exposure to a predetermined temperature at or above a shrinkage initiating temperature of the material of the thermally shrinkable fiber) in one or more of the treatment fluids, but otherwise use conventional fracturing techniques known in the art.

The term “thermally shrinkable fiber” refers to a fiber that (upon exposure to a predetermined temperature at or above a shrinkage initiating temperature of the material of the fiber) is capable of shrinking to a length (the longest linear dimension of the fiber) that is about 80 or less percent of the initial length the thermally shrinkable fiber measured at standard temperature (25° C.) and pressure (1 atmosphere) (“STP”), such as a fiber that (upon exposure to a predetermined temperature at or above a shrinkage initiating temperature of the material of the fiber) is capable of shrinking to a length that is about 60 or less percent of the initial length the thermally shrinkable fiber measured at STP, or a fiber that (upon exposure to a predetermined temperature at or above a shrinkage initiating temperature of the material of the fiber) is capable of shrinking to a length that is in the range of from about 20% to about 50% of the initial length the thermally shrinkable fiber measured at STP. In some embodiments, the thermally shrinkable fiber is capable of shrinking to the extent indicated above and/or a maximum percent shrinkage without degrading.

The term “(thermally) non-shrinkable fiber” refers to a fiber having no thermal shrinkability, as well as a fiber that has thermal shrinkability but does not substantially shrink at or below the highest temperature to which the fibers of the treatment fluid will be exposed.

The term “shrinkage initiating temperature” (of a thermally shrinkable fiber) refers to the temperature at which the thermally shrinkable fiber starts shrinking (relative to the length of the thermally shrinkable fiber measured at STP), such as the temperature at which the length of the thermally shrinkable fiber shrinks to a length that is about 99% of the initial length of the thermally shrinkable fiber measured at STP, or the temperature at which the length of the thermally shrinkable fiber shrinks to a length that is about 90% of the initial length of the thermally shrinkable fiber measured at STP.

After the thermally shrinkable fiber has been exposed to a temperature at or above the shrinkage initiating temperature such that the thermally shrinkable fiber shrinks at least about 20% in length (the longest linear dimension of the fiber) the fiber may be referred to as a “shrunken fiber.” In other words, the term “shrunken fiber” refers to a fiber that has a percent shrinkage (with respect to the longest linear dimension of the fiber, that is, the length of the fiber) of at least 20. The term “percent shrinkage” is defined as:

$$\frac{\begin{matrix}( fiber {length}_{( before shrinkage )} measured at STP ) - \\ ( fiber {length}_{( after shrinkage )} measured at {T}_{1} )\end{matrix}}{fiber {length}_{before shrinkage } measured at STP} * 100$$

where T₁ is the temperature that was used to obtain the shrunken fiber.

In some embodiments, the materials of the thermally shrinkable fiber may be selected such that the shrinkage initiating temperature is in the range of from about 40° C. to about 180° C., or in the range of from about 50° C. to about 150° C. In some embodiments, prior to exposure to the shrinkage initiating temperature the thermally shrinkable fibers have not been exposed to a temperature within 10° C. of the shrinkage initiating temperature.

The thermally shrinkable fibers (and the shrunken fibers formed therefrom) thickness (diameter), density and/or concentration may be selected to be any suitable value that is effective to prevent and/or inhibit particulate material flowback (such as proppant, natural formation particulates and fines) upon being heated to a predetermined temperature sufficient to form a porous pack comprising shrunken fibers. For example, in some embodiments the thermally shrinkable fiber length (such as greater than 4 mm, such as a thermally shrinkable fiber length in the range of from about 4 mm to about 30 mm, or in the range of from about 5 mm to about 20 mm) and concentration (such as a concentration in the range of from about 0.5 to about 10% by weight of proppant, or a concentration in the range of from about 1 to about 4% by weight of proppant, or a concentration in the range of from about 1 to about 2% by weight of proppant) may be selected to allow the thermally shrinkable fibers to overlap before shrinkage takes place.

In some embodiments, such a fiber may amorphous or may have an amorphous part or region, such as an amorphous part or region that allows for the fiber to micro-crimp. The term “amorphous” refers, for example, to areas or regions of a material such as, for example, a polymeric region of the thermally shrinkable fibers, characterized as having no molecular lattice structure and/or having a disordered or not well-defined spatial relationship between molecules, such as a mixture of polymer molecules that is disordered (e.g., where the spatial relationship between monomer units of adjacent polymer molecules is not uniform or fixed, as opposed to a crystalline polymer region). The term “semi-crystalline” refers, for example, to areas or regions of a material such as, for example, a polymeric region of the thermally shrinkable fibers, that is characterized as having a structure that is partially amorphous and partially crystalline, but not completely one or the other. The term “crystalline” refers, for example, to areas or regions of a material such as, for example, regions having a three-dimensional ordering on atomic (rather than macromolecular) length scales, usually arising from intramolecular folding and/or stacking of adjacent chains.

In some embodiments, the thermally shrinkable fiber may have any desired length (as measured at STP), such as a thermally shrinkable fiber length in the range of from about 4 mm to about 50 mm, or in the range of from about 4 mm to about 20 mm, or in the range of from about 6 mm to about 10 mm. In some embodiments, the thermally shrinkable fibers may have any desired average length (as measured at STP), such as a thermally shrinkable fiber average length in the range of from about 4 mm to about 20 mm, or in the range of from about 4 mm to about 10mm, or in the range of from about 6 mm to about 8 mm.

In some embodiments, the shrunken fiber may have any desired length (as measured at STP), such as a shrunken fiber length in the range of from about 0.3 mm to about 30 mm, or in the range of from about 1 mm to about 12 mm, or in the range of from about 2 mm to about 6 mm. In some embodiments, the shrunken fibers may have any desired average length (as measured at STP), such as a shrunken fiber average length in the range of from about 0.3 mm to about 20 mm, or in the range of from about 1 mm to about 5 mm.

In some embodiments, the thermally shrinkable fibers may have an average thickness (diameter) in the range of from about 5 μm to about 100 μm, such as in the range of from about 15 μm to about 40 μm, or in the range of from about 17 μm to about 35 μm. The shrunken fibers may have an average thickness (diameter) in the range of from about 15 μm to about 40 μm, or in the range of from about 20 μm to about 30 μm.

The thermally shrinkable fibers may have an aspect ratio in the range of from about 200 to about 3000, or in the range of from about 200 to about 1000. The shrunken fibers may have an aspect ratio in the range of from about 300 to about 1000, or in the range of from about 300 to about 700. As used herein, the “aspect ratio” of a fiber is defined as the ratio of its length (that is, its longest dimension) to its diameter (that is, its shortest dimension).

In some embodiments, the thermally shrinkable fibers may have an average density in the range of from about 1.1g/cm³ to about 1.4 g/cm³, or in the range of from about 1.1 g/cm³ to about 1.25 g/cm³. The shrunken fibers may have an average density in the range of from about 1.0 g/cm³ to about 1.3 g/cm³, or in the range of from about 1.05 g/cm³ to about 1.25 g/cm³. In some embodiments, the thermally shrinkable fibers, shrunken fibers, and/or thermally non-shrinkable fibers may be may be selected such that the density thereof matches that of the particulate materials, such as proppants, employed, or the thermally shrinkable fibers, shrunken fibers, and/or thermally non-shrinkable fibers may be may be selected to have an average density that is within ±2% of the average density of the particulate materials, such as proppants, employed.

A wide range of fiber shapes (for any of the fibers, such as thermally shrinkable fibers, shrunken fibers, and/or thermally non-shrinkable fibers) may be used in the methods of the present disclosure. For example, in some embodiments, the thermally shrinkable fibers, shrunken fibers, and/or thermally non-shrinkable fibers have coaxial sheath/core structure.

In some embodiments, the fiber, such as a thermally shrinkable fiber, a shrunken fiber, and/or a thermally non-shrinkable fiber, may be a monofilament fiber, a bi-component fiber with a core/sheath coaxial structure, a bi-component fiber with a side-by-side structure, or any other multi-component fiber configuration. Such fibers can have a variety of cross-sectional shapes ranging from simple round cross-sectional areas, oval cross-sectional areas, trilobe cross-sectional areas, star shaped cross-sectional areas, rectangular cross-sectional cross-sectional areas or the like. In embodiments, the fiber used in the methods of the present disclosure (such as a thermally shrinkable fiber, a shrunken fiber, and/or a thermally non-shrinkable fiber) may be straight. In some embodiments, the fiber (such as a thermally shrinkable fiber, a shrunken fiber, and/or a thermally non-shrinkable fiber) used in the methods of the present disclosure may be a fiber that is curved, crimped, or spiral-shaped. In some embodiments, the fiber (such as a thermally shrinkable fiber, a shrunken fiber, and/or a thermally non-shrinkable fiber) used in the methods of the present disclosure may be a fiber that is made to assume a curved, crimped, or spiral-shaped geometry as a result of the shrinking process. In some embodiments, the fiber (such as a thermally shrinkable fiber, a shrunken fiber, and/or a thermally non-shrinkable fiber) used in the methods of the present disclosure may be hooked on one or both ends (or made with such components or materials that the shrunken fiber takes on such a geometry upon shrinking).

In some embodiments, the fiber (such as a thermally shrinkable fiber, a shrunken fiber, and/or a thermally non-shrinkable fiber) used in the methods of the present disclosure may be of a composite structure. For example, more than one material may make up the monofilament fiber, the sheath of a bi-component fiber with a core/sheath coaxial structure, or the sheath of a bi-component fiber with a core/sheath coaxial structure. In some embodiments, the materials from which the thermally shrinkable fibers, shrunken fibers, and/or thermally non-shrinkable fibers are formed may not chemically interact with components of the well treatment fluids and may be stable in the subterranean environment.

In embodiments, the outermost surface of the thermally shrinkable fiber may be an amorphous polymer capable of shrinking upon exposure to a predetermined temperature at or above the shrinking initiation temperature of the polymer, such as amorphous polylactic acid. Other suitable amorphous polymers that capable of shrinking upon exposure to a predetermined temperature at or above the shrinking initiation temperature of the polymer that can be used in the methods of the present disclosure include, for example, polystyrene, poly(methyl methacrylate) and polyethylene terephthalate. Such polymers may serve as the sheath in thermally shrinkable fibers having a core/sheath coaxial structure. In such embodiments, the core of the thermally shrinkable fibers having a core/sheath coaxial structure may be a crystalline or semi-crystalline polymer, such as semi-crystalline polylactic acid. Other suitable crystalline or semi-crystalline polymers that are capable of shrinking upon exposure to a predetermined temperature at or above the shrinking initiation temperature of the polymer that can be used in the methods of the present disclosure include, for example, polyethylene, polypropylene and polyethylene terephthalate.

In some embodiments, the sheath and the core may be composed of the same polymer material (such as polylactic acid) where the core and the sheath have a different degree of crystallinity (the core being of a material that is more crystalline than the sheath). For example, in some embodiments, the sheath of the thermally shrinkable fibers may be amorphous and the core of the thermally shrinkable fibers may be semi-crystalline. In some embodiments, the sheath and the core of the thermally shrinkable fibers may shrink simultaneously after being exposed to heating conditions. In some embodiments, the materials of the core and sheath of the thermally shrinkable fibers may be selected such that the difference in shrinkage degree is brought about by exposing the thermally shrinkable fibers have coaxial sheath/core structure to a temperature above the shrinkage initiation temperature of the core and sheath materials because the sheath shrinks to a larger extent than core. Such a difference in shrinkage between the sheath and the core generates a stress between the components (between sheath and core components of the thermally shrinkable fibers) results in a shrunken fiber having a micro-crimped structure. In embodiments, the micro-crimps present in the shrunken fibers increase the amount of mechanical association (for example, physical interaction and tangling) of the resulting shrunken fiber and result in a more dense 3D network of tangled shrunken fibers with proppant particles dispersed between shrunken micro-crimped fibers.

In embodiments, an average diameter of the core of the thermally shrinkable fibers having a core/sheath coaxial structure may be in the range of from about 5 μm to about 50 μm, such as in the range of from about 10 μm to about 30 μm. In embodiments, the sheath layer of the thermally shrinkable fibers having a core/sheath coaxial structure may have a thickness in the range of from about 4 μm to about 50 μm, such as in the range of from about 6 μm to about 20 μm.

The thermally shrinkable fiber may be present in the treatment fluid in any amount that is effective to form a porous pack upon exposure to a predetermined temperature at or above the shrinking initiation temperature of the polymer. In some embodiments, the thermally shrinkable fibers are present in the treatment fluid in an amount in the range of from about 0.3 to about 2.5% by weight of the treatment fluid, or in the range of from about 0.4 to about 1.8% by weight of the treatment fluid. In embodiments, the shrunken fiber amounts present in the porous pack, such as a proppant pack, may be in the range of from about 0.2 to about 10% by weight of the porous pack, such as in the range of from about 0.3 to about 5% by weight of the porous pack, or in the range of from about 0.3 to about 2.5% by weight of the porous pack, such as a proppant pack.

In embodiments, any desired particulate material may be used in the methods of the present disclosure, provided that it is compatible with the thermally shrinkable and/or shrunken fibers of the present disclosure, the formation, the fluid, and the desired results of the treatment operation. For example, particulate materials may include sized sand, synthetic inorganic proppants, coated proppants, uncoated proppants, resin coated proppants, and resin coated sand.

In embodiments where the particulate material is a proppant, the proppant used in the methods of the present disclosure may be any appropriate size to prop open the fracture and allow fluid to flow through the proppant pack, that is, in between and around the proppant making up the pack. In some embodiments, the proppant may be selected based on desired characteristics, such as size range, crush strength, and insolubility. In embodiments, the proppant may have a sufficient compressive or crush resistance to prop the fracture open without being deformed or crushed by the closure stress of the fracture in the subterranean formation. In embodiments, the proppant may not dissolve in treatment fluids commonly encountered in a well.

Any proppant may be used, provided that it is compatible with the thermally shrinkable and/or shrunken fibers of the present disclosure, the formation, the fluid, and the desired results of the treatment operation. Such proppants may be natural or synthetic (including silicon dioxide, sand, nut hulls, walnut shells, bauxites, sintered bauxites, glass, natural materials, plastic beads, particulate metals, drill cuttings, ceramic materials, and any combination thereof), coated, or contain chemicals; more than one may be used sequentially or in mixtures of different sizes or different materials. The proppant may be resin coated, provided that the resin and any other chemicals in the coating are compatible with the other chemicals of the present disclosure, such as the thermally shrinkable and/or shrunken fibers of the present disclosure.

The proppant used may have an average particle size of from about 0.15 mm to about 2.39 mm (about 8 to about 100 U.S. mesh), or of from about 0.25 to about 0.43 mm (40/60 mesh), or of from about 0.43 to about 0.84 mm (20/40 mesh), or of from about 0.84 to about 1.19 mm (16/20), or of from about 0.84 to about 1.68 mm (12/20 mesh) and or of from about 0.84 to about 2.39 mm (8/20 mesh) sized materials. The proppant may be present in a slurry (which may be added to the treatment fluid) in a concentration of from about 0.12 to about 3 kg/L, or about 0.12 to about 1.44 kg/L (about 1 PPA to about 25 PPA, or from about 1 to about 12 PPA; PPA is “pounds proppant added” per gallon of liquid).

The methods of the present disclosure may include providing and/or forming porous packs comprising shrunken fibers (and particulate material) during a treatment operation of a subterranean formation. In some embodiments, the present disclosure provides for formation of a porous solid pack (including particulate materials and shrunken fibers) that prevents and/or inhibits the flow of both deposited proppant and natural formation particulates (and fines) back through the wellbore with the production of formation fluids. This porous pack (including particulate materials and shrunken fibers) may filter out unwanted particles, proppant and fines, while allowing production of reservoir fluids, such as oil.

In some embodiments, the porous pack of particulate materials formed during the methods of the present disclosure may comprise thermally shrinkable fibers and/or shrunken fibers that have not reached their maximum percent shrinkage. The maximum percent shrinkage is defined as

$$\frac{\begin{matrix}( fiber {length}_{( before shrinkage )} measured at STP ) - \\ ( minimum fiber {length}_{( after shrinkage )} measured at {T}_{m} )\end{matrix}}{fiber {length}_{before shrinkage } measured at STP} * 100$$

where Tₘ is the temperature at which maximum shrinkage of the fiber occurs (without degradation). In such embodiments where the thermally shrinkable fibers do not achieve their maximum percent shrinkage, the shrunken fibers may have further thermal shrinkability, such as if the temperature to which the fibers are being exposed to is increased to a higher value. In some embodiments, the porous pack of particulate materials formed during the methods of the present disclosure that comprise thermally shrinkable fibers and/or shrunken fibers that have not reached their maximum percent shrinkage may be subjected to an event in which the thermally shrinkable fibers and/or shrunken fibers are made to form an association, such as a mechanical association, covalent association and/or non-covalent association, with the one or more other thermally shrinkable fibers and/or shrunken fibers and/or one or more thermally non-shrinkable fibers. Thereafter, increasing the temperature of such porous packs (including particulate materials and thermally shrinkable fibers and/or shrunken fibers that possess further thermal shrinkability), such as by the action of a radiation source, may increase the trapping capacity of the fiber network strength and increase filtering capacity of the porous proppant pack.

In the methods of the present disclosure, channels may be formed in the porous pack of particulate materials and shrunken fibers to selectively prohibit production of undesirable particles, while still allowing production of formation fluids, such as hydrocarbons and/or oil. In some embodiments, the porous pack (including particulate materials and shrunken fibers) may be selectively fitted with voids, finger-shaped projections, or “channels.” Such channels may be located within the structure of the porous pack (including particulate materials and shrunken fibers), and serve to provide a permeable barrier that retards flowback of particles, but still allows production of reservoir fluids, such as hydrocarbons and oil, at sufficiently high rates.

In some embodiments, the methods of the present disclosure include forming a porous pack of particulate materials (which are either are pumped into a wellbore with a well treatment fluid or are present as a result of unconsolidated formation fines) and shrunken fibers.

In some embodiments, an additional fibrous material may also be included in the treatment fluid and/or incorporated into the porous pack. For example, the treatment fluid may comprise a thermally shrinkable fiber and a thermally non-shrinkable fiber. The thermally non-shrinkable fiber (when present in combination with the thermally shrinkable fibers (and resulting shrunken fibers formed therefrom)) thickness (diameter), density and concentration may be any suitable value that is effective to assist in preventing and/or inhibit particulate material flowback. The thermally non-shrinkable fiber may be one or more member selected from natural fibers, synthetic organic fibers, glass fibers, ceramic fibers, carbon fibers, inorganic fibers, metal fibers, a coated form of any of the above fibers, that either have no thermal shrinkability, or have thermal shrinkability but do not substantially shrink (that is, more than about 1% or about 2% in length) at or below the highest temperature to which the fibers will be exposed to during the treatment operation.

In some embodiments, the thermally shrinkable fibers may be pumped with a particulate material, such as proppant, such that the thermally shrinkable fibers are uniformly mixed with the particulate material. In some embodiments, a dispersion of the thermally shrinkable fibers and the proppant may be introduced, such as by pumping, into the subterranean formation. The terms “dispersion” and “dispersed” refer, for example, to a substantially uniform distribution of components (such as thermally shrinkable fiber and particulate material) in a mixture. In some embodiments, a dispersed phase of one or more fibers, comprising thermally shrinkable fibers, and particulate material may be formed at the surface. An action or event occurring “at the surface” refers, for example, to an action or event that happens above ground, that is, not at an underground location, such as within the wellbore or within the subterranean formation.

In some embodiments, the thermally shrinkable fibers (and optionally shrunken fibers and/or thermally non-shrinkable fibers) may be mixed and dispersed throughout the entire batch of proppant to be pumped into the wellbore during the treatment operation. This may occur by adding the thermally shrinkable fibers (and optionally shrunken fibers and/or thermally non-shrinkable fibers) to the proppant before it is mixed with the treatment fluid, adding the thermally shrinkable fibers (and optionally shrunken fibers and/or thermally non-shrinkable fibers) to the treatment fluid before it is mixed with the proppant, or by adding a slurry of thermally shrinkable fibers (and optionally shrunken fibers and/or thermally non-shrinkable fibers) at some other stage, such either before the slurry is pumped downhole, or at a location downhole.

In embodiments, after the slurry including thermally shrinkable fibers (and optionally shrunken fibers and/or thermally non-shrinkable fibers) and particulate material is pumped downhole, or is placed at a location downhole (such a fracture), an increase in temperature (to a temperature at or above the shrinking initiating temperature of the thermally shrinkable fiber) may be brought about by any suitable means such that a temperature-induced transition occurs that results in the length of the thermally shrinkable fibers (linear dimension) being reduced (that is, the fibers shrink to form a shrunken fiber), which creates a shrunken fiber network that traps the particulate material and prevents and/or inhibits the flow of both deposited particulate material, such as proppant, natural formation particulates (and fines) back through the wellbore with the production of formation fluids.

In some embodiments, the methods of the present disclosure may comprise dispersing the thermally shrinkable fibers and a particulate material in a treatment fluid; injecting the treatment fluid into a subterranean formation via a wellbore; applying heat sufficient to raise the temperature of the thermally shrinkable fibers to a temperature at or above the shrinking initiation temperature; and producing fluid free of particulate matter from the subterranean formation.

In some embodiments, the methods of the present disclosure may include the following actions, in any order: placing a treatment fluid including thermally shrinkable fibers and a particulate material into a subterranean formation via a wellbore; adjusting at least one parameter of the treatment fluid to trigger the association, such as a mechanical association, covalent association and/or non-covalent association, of the thermally shrinkable fibers, wherein the thermally shrinkable fibers optionally form an association, such as a mechanical association, covalent association and/or non-covalent association, with one or more thermally non-shrinkable fibers; and forming a network of shrunken fibers by applying heat sufficient to raise the temperature of the thermally shrinkable fibers to a temperature at or above the shrinking initiation temperature. The terms “placing” or “placed” refer to the addition of a treatment fluid to a subterranean formation by any suitable means and, unless stated otherwise, do not imply any order by which the actions occur. The term “introduced” refers when used in connection with the addition of a treatment fluid to a subterranean formation may imply an order of accomplishing the recited actions, if not stated otherwise.

As used herein, the phrase “to trigger a mechanical association,” refers to any action that is sufficient to initiate the formation of a mechanical association. The mechanical associations may include, for example, physical interactions and/or tangling. In some embodiments, such mechanical associations may occur to the extent that the resulting shrunken fiber may form a dense 3D network of tangled shrunken fibers with proppant particles dispersed between the shrunken fibers, such as a dense 3D network of tangled shrunken micro-crimped fibers with proppant particles dispersed between the shrunken micro-crimped fibers. In some embodiments, the thermally shrinkable fibers may be exposed to a thermal means and/or other means to initiate or otherwise induce or cause the thermally shrinkable fibers to entangle, physically and/or mechanically interact, and/or adhere to one another. In some embodiments, the at least one parameter that is adjusted to trigger the mechanical association between the thermally shrinkable fibers may be, for example, a pH change, a temperature change, a change in hydrophobicity, and/or a change in the solvent composition.

In some embodiments, the association that may be triggered is a covalent association and/or a non-covalent association (which may also include one or more physical or mechanical associations), one or more covalent bonds and/or one or more non-covalent bonds (such as an ionic bond) between the thermally shrinkable fibers (and optionally between the thermally shrinkable fibers and either a thermally non-shrinkable fiber, a particulate material, such as a proppant or coated proppant, or one or more of these components). For example, the thermally shrinkable fibers may be exposed to chemical means, thermal means and other means to initiate, catalyze, or otherwise induce or cause the thermally shrinkable fibers to physically and/or mechanically interact, covalently bond and/or adhere (via non-covalent bonds, such as intermolecular forces) to one another. In some embodiments, the at least one parameter that is adjusted to trigger the mechanical association, covalent association and/or non-covalent association between the thermally shrinkable fibers may be, for example, a pH change, a temperature change, a change in hydrophobicity, and/or a change in the solvent composition, and/or a change in the molecular weight (such as a cross-linking reactions between the thermally shrinkable fibers).

In embodiments, after the thermally shrinkable fibers and a particulate material are present in the subterranean formation in a dispersed phase the thermally shrinkable fiber may be triggered to shrink by increasing the temperature to a temperature at or above the shrinking initiating temperature such that a transition occurs that results in the length of the shrinkable fibers (linear dimension) being reduced (that is, the fibers shrink) such that the fibers become entangled and trap the particulate material in a mat or other three-dimensional framework that holds the particulate material in place thereby reducing and/or eliminating particulate material flowback with the fluid production.

In some embodiments, the slurry of proppant and thermally shrinkable fibers (and optionally shrunken fibers and/or thermally non-shrinkable fibers) may be pumped into the wellbore during a portion of the treatment operation, for example, as the last about 5 to about 25% of the proppant is placed into the fracture, such as to control flowback without using vast amounts of thermally shrinkable fibers (and optionally shrunken fibers and/or thermally non-shrinkable fibers). Such a slug may also be pumped into the wellbore at other stages, for example, to provide an absorbed scale inhibitor to be pumped to the front of the fracture.

In some embodiments, small slugs of a slurry of proppant and thermally shrinkable fibers (and optionally shrunken fibers and/or thermally non-shrinkable fibers) may be pumped in between slugs of slurry of proppant, or small slugs of a slurry of thermally shrinkable fibers (and optionally shrunken fibers and/or thermally non-shrinkable fibers) may be pumped between slugs of a proppant slurry. Such a series of stages may be used to control flow dynamics down the fracture, for example, by providing more plugflow-like behavior. Pumping of small slugs of slurry of thermally shrinkable fibers (and optionally shrunken fibers and/or thermally non-shrinkable fibers) as the tail-in is an example of this type of procedure in a treatment operation.

In embodiments, a slurry of a mixture of proppant and thermally shrinkable fibers (and optionally shrunken fibers and/or thermally non-shrinkable fibers) may be used for any desired reason in the entire range of reservoir applications, such as from fracturing to sand control, frac-and-sand-pack and/or high permeability stimulation. For example, the methods of the present disclosure may be used in fluid loss applications. In some embodiments, in areas of high fluid loss, the thermally shrinkable fibers (and optionally shrunken fibers and/or thermally non-shrinkable fibers) and a particulate material, such as sand, may concentrate into a mat, which may then be strengthened by triggering (by a temperature increase) the thermally shrinkable fibers to shrink (that is transition into shrunken fibers), thereby limiting additional fluid loss in these areas.

In some embodiment, thermally shrinkable fibers and/or the shrunken fibers generated therefrom (and optionally thermally non-shrinkable fibers) may be used to design complex flow channels in the proppant pack. For example, a fracturing operation may be engineered such that voids or channels (sometimes called “fingers”) of proppant flow out of the proppant pack after the pack is formed downhole, resulting in the creation of open channels which allow well fluids to flow into the wellbore without substantial restriction. In such embodiments, the proppant pack may provide an effective barrier to particles, proppant or fines that otherwise would otherwise flood into the wellbore.

Such fingers may range in length from about one inch to several feet, or in some embodiments, be even longer. The fingers may be created in any desired manner. For example, the well can be flowed back at a rate sufficient to create channels without loss of the majority of the proppant pack. A shrunken fiber proppant pack, such as one which also utilizes glass fibers, may be treated with mud acid (an aqueous solution of hydrochloric acid and hydrofluoric acid) under matrix conditions to dissolve the fibers within the porous pack in finger-like patterns. This may be accomplished at treating pressures less than that commonly used to fracture the formation. When the well is allowed to flow, the proppant will be produced back from those finger-like areas which no longer contain any fibers.

This type of process, or other similar known processes, results in the selective creation of a customized pack-in-place wherein the pack contains a series of concentrations of shrunken fiber/proppant mixtures. For example, the majority of the fracture could be packed with a proppant pack containing, for example, about 1.5% fibers as a total fiber/proppant mixture by weight. During the final tail-in at the end of the fracturing job (such as during the last about 1% to about 15% of the total proppant placed in the well), the amount of shrunken fibers could be decreased such that some lower level of fiber concentration, for example, about 1% fibers could be utilized.

As indicated above, the treatment fluid carrying the thermally shrinkable fibers (and optionally shrunken fibers and/or thermally non-shrinkable fibers) may be any well treatment fluid, such as a fluid loss control pill, a water control treatment fluid, a scale inhibition treatment fluid, a fracturing fluid, a gravel packing fluid, a drilling fluid, and a drill-in fluid. The carrier solvent for the treatment fluid may be a pure solvent or a mixture. Suitable solvents for use with the methods of the present disclosure, such as for forming the treatment fluids disclosed herein, may be aqueous or organic based. Aqueous solvents may include at least one of fresh water, sea water, brine, mixtures of water and water-soluble organic compounds and mixtures thereof. Organic solvents may include any organic solvent that is able to dissolve or suspend the various components, such as the chemical entities and/or components of the treatment fluid.

Suitable organic solvents may include, for example, alcohols, glycols, esters, ketones, nitrites, amides, amines, cyclic ethers, glycol ethers, acetone, acetonitrile, 1-butanol, 2-butanol, 2-butanone, t-butyl alcohol, cyclohexane, diethyl ether, diethylene glycol, diethylene glycol dimethyl ether, 1,2-dimethoxy-ethane (DME), dimethylether, dibutylether, dimethyl sulfoxide (DMSO), dioxane, ethanol, ethyl acetate, ethylene glycol, glycerin, heptanes, hexamethylphosphorous triamide (HMPT), hexane, methanol, methyl t-butyl ether (MTBE), N-methyl-2-pyrrolidinone (NMP), nitromethane, pentane , petroleum ether (ligroine), 1-propanol, 2-propanol, pyridine, tetrahydrofuran (THF), toluene, triethyl amine, o-xylene, m-xylene, p-xylene, ethylene glycol monobutyl ether, polyglycol ethers, pyrrolidones, N-(alkyl or cycloalkyl)-2-pyrrolidones, N-alkyl piperidones, N, N-dialkyl alkanolamides, N,N,N′,N′-tetra alkyl ureas, dialkylsulfoxides, pyridines, hexaalkylphosphoric triamides, 1,3-dimethyl-2-imidazolidinone, nitroalkanes, nitro-compounds of aromatic hydrocarbons, sulfolanes, butyrolactones, alkylene carbonates, alkyl carbonates, N-(alkyl or cycloalkyl)-2-pyrrolidones, pyridine and alkylpyridines, diethylether, dimethoxyethane, methyl formate, ethyl formate, methyl propionate, acetonitrile, benzonitrile, dimethylformamide, N-methylpyrrolidone, ethylene carbonate, dimethyl carbonate, propylene carbonate, diethyl carbonate, ethylmethyl carbonate, dibutyl carbonate, lactones, nitromethane, nitrobenzene sulfones, tetrahydrofuran, dioxane, dioxolane, methyltetrahydrofuran, dimethylsulfone, tetramethylene sulfone, diesel oil, kerosene, paraffinic oil, crude oil, liquefied petroleum gas (LPG), mineral oil, biodiesel, vegetable oil, animal oil, aromatic petroleum cuts, terpenes, mixtures thereof.

While the treatment fluids of the present disclosure are described herein as comprising the above-mentioned components, it should be understood that the treatment fluids of the present disclosure may optionally comprise other chemically different materials. In embodiments, the treatment fluid may further comprise stabilizing agents, surfactants, diverting agents, or other additives. Additionally, a treatment fluid may comprise a mixture of various crosslinking agents, and/or other additives, such as fibers or fillers, provided that the other components chosen for the mixture are compatible with the intended use of the treatment fluid. Furthermore, the treatment fluid may comprise buffers, pH control agents, and various other additives added to promote the stability or the functionality of the treatment fluid. The components of the treatment fluid may be selected such that they may or may not react with the subterranean formation that is to be treated.

In this regard, the treatment fluid may include components independently selected from any solids, liquids, gases, and combinations thereof, such as slurries, gas-saturated or non-gas-saturated liquids, mixtures of two or more miscible or immiscible liquids, and the like, as long as such additional components allow for the precipitation of the chemical entity and/or reaction product thereof upon exposure to the precipitation triggering event. For example, the treatment fluid may comprise organic chemicals, inorganic chemicals, and any combinations thereof. Organic chemicals may be monomeric, oligomeric, polymeric, crosslinked, and combinations, while polymers may be thermoplastic, thermosetting, moisture setting, elastomeric, and the like. Inorganic chemicals may be metals, alkaline and alkaline earth chemicals, minerals, and the like.

Stabilizing agents can be added to slow the degradation of the precipitated structure after its formation downhole. Typical stabilizing agents may include buffering agents, such as agents capable of buffering at pH of about 8.0 or greater (such as water-soluble bicarbonate salts, carbonate salts, phosphate salts, or mixtures thereof, among others); and chelating agents (such as ethylenediaminetetraacetic acid (EDTA), nitrilotriacetic acid (NTA), or diethylenetriaminepentaacetic acid (DTPA), hydroxyethylethylenediaminetriacetic acid (HEDTA), or hydroxyethyliminodiacetic acid (HEIDA), among others). Buffering agents may be added to the treatment fluid in an amount of at least about 0.05 wt %, such as from about 0.05 wt % to about 10 wt %, and from about 0.1 wt % to about 2 wt %, based upon the total weight of the treatment fluid. Chelating agents may be added to the treatment fluid in an amount of at least about 0.75 mole per mole of metal ions expected to be encountered in the downhole environment, such as at least about 0.9 mole per mole of metal ions, based upon the total weight of the treatment fluid.

In embodiments, the treatment fluid may be driven into a wellbore by a pumping system that pumps one or more treatment fluids into the wellbore. The pumping systems may include mixing or combining devices, wherein various components, such as fluids, solids, and/or gases maybe mixed or combined prior to being pumped into the wellbore. The mixing or combining device may be controlled in a number of ways, including, but not limited to, using data obtained either downhole from the wellbore, surface data, or some combination thereof.

Fracturing a subterranean formation may include introducing hundreds of thousands of gallons of treatment fluid, such as a fracturing fluid, into the wellbore. In some embodiments a frac pump may be used for hydraulic fracturing. A frac pump is a high-pressure, high-volume pump, such as a positive-displacement reciprocating pump. In embodiments, a treatment fluid comprising the thermally shrinkable fibers (and optionally shrunken fibers and/or thermally non-shrinkable fibers) may be introduced by using a frac pump, such that the treatment fluid (such as a fracturing fluid) may be pumped down into the wellbore at high rates and pressures, for example, at a flow rate in excess of about 20 barrels per minute (about 4,200 U.S. gallons per minute) at a pressure in excess of about 2,500 pounds per square inch (“psi”). In some embodiments, the pump rate and pressure of the treatment fluid (such as a fracturing fluid) may be even higher, for example, at flow rates in excess of about 100 barrels per minute and pressures in excess of about 10,000 psi may be used.

The foregoing is further illustrated by reference to the following examples, which are presented for purposes of illustration and are not intended to limit the scope of the present disclosure.

### EXAMPLES

Fiber Sample 1 (comparative example): a fiber of glass with length of 10-14 millimeters and an average diameter of 19.5 tm was selected as a thermally non-shrinkable fiber. It was used at concentration of 1.1% by weight of proppant (BWOP) added. 218.9 grams of proppant was used for each test, and thus the fiber amount was (218.9×0.011) 2.4 grams.

Fiber Samples 2-4: a bi-component fiber (core/sheath coaxial structure) with an average length of 6 millimeters and average fiber diameter of 15 tm and 21 tm was selected as that thermally shrinkable fiber. The core of the fiber was made of crystalline polylactic acid (PLA), and the sheath was made of amorphous PLA. It was used in various concentrations (such as 1.1% by weight, 1.0% by weight, and 0.8% by weight) BWOP.

For each of the fiber samples, a slurry was prepared with 120 milliliters of a linear gel sample mixed with 218.9 grams of proppant and the respective fiber. A persulfate breaker was added to the respective slurry. After mixing until the respective slurry reached homogeneous condition, it was crosslinked by addition of a borate crosslinker. After crosslinking the respective slurry, the sample was evenly distributed on a flowback cell.

The cell includes a 5.25×5.25 inch chamber with a cavity where the sample is placed and moving plunger above the sample. Setup has a heater for heating the sample. The closure stress is applied on the moving piston. The water flow rate through the cell with loaded sample was ramped up and the pressure drop through the cell was being recorded. An instant drop of pressure differential represented a failure of the pack. The value of pressure drop and flow rate at which the pack failed was used for relative comparison of the effectiveness of different flowback samples.

A closure stress was applied on the pack and it was heated to a temperature of either 60 or 80° C. The temperature was maintained for 30 minutes, then heating was stopped and flow of 40° C. tap water at a rate of 0.1 liter/minute was initiated through the pack to remove the broken crosslinked gel. Around 1 liter of water was used to flush the pack. After the pack was flushed, the flow of 40° C. tap water through the pack was ramped up from 0.1 Liter/minute until the proppant pack failed. During the test, the pressure drop through the pack was recorded versus flow rate applied. Proppant pack failure was marked by the rapid decrease of pressure, which indicates partial or full wash-out of proppant from the pack.

The results showed that the samples with the thermally shrinkable proppant were able to hold the proppant at flow rates about two to seven times higher than that of the thermally non-shrinkable fiber sample.

Although the preceding description has been described herein with reference to particular means, materials and embodiments, it is not intended to be limited to the particulars disclosed herein; rather, it extends to all functionally equivalent structures, methods and uses, such as are within the scope of the appended claims. Furthermore, although only a few example embodiments have been described in detail above, those skilled in the art will readily appreciate that many modifications are possible in the example embodiments without materially departing from the disclosure of METHODS OF TREATING A SUBTERRANEAN FORMATION WITH SHRINKABLE FIBERS. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

1. A method for treating a subterranean formation comprising:
introducing a treatment fluid including thermally shrinkable fibers and a particulate material into a subterranean formation via a wellbore;
thermally triggering a mechanical association of the thermally shrinkable fibers; and
after triggering the mechanical association of the thermally shrinkable fibers, forming a porous pack comprising a network of shrunken fibers by conducting a shrinking process including applying heat sufficient to raise the temperature of the thermally shrinkable fibers to a temperature at or above a shrinking initiation temperature of the thermally shrinkable fibers; wherein at least a portion of the shrunken fibers are made to assume a geometry in which the shrunken fiber is hooked on one or both ends as a result of the shrinking process.

2. The method of claim 1, further comprising preventing a flowback of one or more particles through the wellbore during a production of formation fluids in a fracturing operation, wherein one or more particles are selected from the group consisting of proppant, natural formation particulates and fines.

3. The method of claim 1, wherein the shrunken fibers have an average length, measured at a temperature at or above a shrinking initiation temperature, that is about 80 or less percent of the average length of the thermally shrinkable fibers measured at 25° C. and pressure of 1 atmosphere.

4. The method of claim 1, wherein the treatment fluid further comprises at least one thermally non-shrinkable fiber that forms a covalent and/or non-covalent association with the thermally shrinkable fiber before the porous pack is formed.

5. The method of claim 1, wherein at least a portion of the particulate material is proppant.

6. The method of claim 1, wherein the shrunken fiber has a length in the range of from about 0.3 mm to about 45 mm.

7. The method of claim 1, wherein the thermally shrinkable fibers are present in the treatment fluid in an amount in the range of from about 0.3% to about 2.5% by weight of the particulate material.

8. The method of claim 1, wherein the shrinkage initiating temperature of the thermally shrinkable fibers is in the range of from about 40° C. to about 180° C.

9. The method of claim 1, wherein the shrunken fibers are present in the porous pack in an amount in the range of from about 0.3 to about 2.5% by weight of the porous pack

10. The method of claim 1, wherein an average diameter of the thermally shrinkable fibers is in the range of from about 10 microns to about 100 microns.

11. The method of claim 1, wherein the thermally shrinkable fibers are capable of shrinking to a length that is in the range of from about 60% to about 90% of their initial length as measured at 25° C. and pressure of 1 atmosphere.

12. The method of claim 1, wherein at least a portion of the thermally shrinkable fibers have a bi-component structure.

13. The method of claim 1, wherein at least a portion of the thermally shrinkable fibers are bi-component thermally shrinkable fibers with a core/sheath coaxial structure.

14. The method of claim 1, wherein at least a portion of the thermally shrinkable fibers are bi-component thermally shrinkable fibers with a core/sheath coaxial structure, where the sheath is an amorphous polymer.

15. The method of claim 1, wherein at least a portion of the thermally shrinkable fibers are bi-component thermally shrinkable fibers with a core/sheath coaxial structure, where the sheath is an amorphous polymer and the core is selected from a crystalline polymer or a semi-crystalline polymer.

16. The method of claim 1, wherein the thermally shrinkable fibers shrink to form the shrunken fibers without degrading.

17. The method of claim 1, wherein
the thermally shrinkable fibers shrink to form the shrunken fibers without degrading, and
the shrunken fibers are stable in the subterranean formation.

18. The method of claim 1, wherein the thermally shrinkable fibers are formed from a polymer selected from the group consisting of polystyrene and poly(methyl methacrylate).

19. A method for treating a subterranean formation comprising:
introducing a treatment fluid including thermally shrinkable fibers and a particulate material into a subterranean formation via a wellbore;
thermally triggering a mechanical association of the thermally shrinkable fibers; and
after triggering the mechanical association of the thermally shrinkable fibers, forming a porous pack comprising a network of shrunken fibers by applying heat sufficient to raise the temperature of the thermally shrinkable fibers to a temperature at or above a shrinking initiation temperature of the thermally shrinkable fibers; wherein
apart from shrinking, the thermally shrinkable fibers are stable in the subterranean formation, and
the shrunken fibers are stable in the subterranean formation.

20. The method of claim 19, wherein the thermally shrinkable fibers are formed from a polymer selected from the group consisting of polystyrene and poly(methyl methacrylate).
